(19) United States
(12) Patent Application Publication
(10) Pub. No.: US 2024/0336330 A1
(43) Pub. Date: Oct. 10, 2024

(54) ACTUATOR FOR THE ACTUATION OF AT LEAST ONE MOVABLE MEMBER OF A VEHICLE TRANSMISSION

(71) Applicant: VALEO SYSTEMES DE CONTROLE MOTEUR, Cergy Pontoise (FR)

(72) Inventors: Quentin CASSARD, Cergy Pontoise (FR); Fabrice RAUTUREAU, Cergy Pontoise (FR); Nicolas LEGRAND, Cergy Pontoise (FR)

(73) Assignee: VALEO SYSTEMES DE CONTROLE MOTEUR, Cergy Pontoise (FR)

(21) Appl. No.: 18/293,610

(22) PCT Filed: Aug. 3, 2022
(86) PCT No.: PCT/EP2022/071881

§ 371 Date: Jan. 30, 2024

(30) Foreign Application Priority Data
Aug. 6, 2021 (FR) FR2108566

(51) Int. Cl. B62M 25/08; F16H 57/02; F16H 57/039; F16H 61/32

(52) U.S. Cl. CPC B62M 25/08; F16H 57/039; F16H 61/32; F16H 2057/02026; F16H 2057/02034; F16H 2057/02082

(57) ABSTRACT

An actuator for the actuation of at least one movable member of a vehicle transmission. The actuator includes an electric motor having a driving shaft on which is mounted a first pinion, a toothed wheel having toothing which mesh with the pinion, and a torque output element able to be coupled to the transmission. The toothed wheel moreover includes an endless screw mechanism meshing with a second pinion mounted on a driven shaft, the driven shaft including a magnetic target facing a sensor.

The invention relates to an actuator for the actuation of at least one movable member of a transmission for a vehicle, in particular a vehicle having at least two wheels, for example a bicycle, also referred to as bike, or a three-wheeled delivery bike, also referred to as tricycle.

The invention is applicable in particular in the field of actuators for changing gear ratios of a transmission or gearbox associated with the vehicle. Such a transmission or gearbox is described in the document WO 2012/156613 A1, for example. However, numerous other applications are possible.

Such an actuator can be used by being coupled to the transmission or gearbox of the vehicle. The vehicle may be an electrically assisted vehicle, that is to say that it comprises an electric drive motor coupled to the transmission of said vehicle. The vehicle may also be conventional, that is to say without electrical assistance.

There is a need to change the gear ratios of the vehicle automatically in order that the transmission operates within its optimum range of use without incurring significant effort on the part of the user and/or of the drive motor. The actuator according to the invention thus simplifies the use of the vehicle for the user, who no longer needs to worry about being in the correct gear ratio.

The document DE 10 2019 123 288 A1 discloses an actuator for changing the gear ratios of a vehicle, in particular a bicycle. The actuator described in said document has the drawback of being bulky owing to a complex mechanism between the electric motor and the output element of the actuator coupled to the transmission.

The object of the present invention is to improve the current solutions, in particular by proposing a compact and lightweight actuator.

More particularly, the invention relates to an actuator for the actuation of at least one movable member of a vehicle transmission, said actuator comprising an electric motor having a driving shaft on which is mounted a first pinion, a toothed wheel having a toothing which mesh with the first pinion, and a torque output element able to be coupled to the transmission, the toothed wheel moreover comprising an endless screw mechanism meshing with a second pinion mounted on a driven shaft, said driven shaft comprising a magnetic target facing a sensor.

In this way, the actuator according to the invention is especially compact while still incorporating a means for detecting the angular position of the torque output element, thereby making it possible to know the exact position of the mobile member of the associated transmission.

According to the invention, the first pinion and the toothing of the toothed wheel form a face gear. This type of gear has the particular feature of being simple to implement, since it requires exact positioning along only two axes and allows robust operation. By definition, a face gear means the association of a disc-shaped gear whose teeth are cut radially on one face with a straight pinion whose axis is substantially perpendicular to the axis of the gear.

According to one feature of the invention, the toothed wheel comprises a first part in the form of a disc having an inner face and an outer face. Said toothing is formed on the periphery of the outer face. The toothed wheel moreover comprises a second part in the form of a bushing extending from the outer face of the first part and on which the torque output element is located. Said first part and second part of the toothed wheel are in one piece.

According to a particular feature of the invention, the endless screw mechanism is located on the second part in the form of a bushing of the toothed wheel. In other words, the endless screw mechanism and the torque output element coincide.

According to a variant embodiment of the invention, the endless screw mechanism is located on the first part in the form of a disc on the outer face of the toothed wheel.

According to one feature of the invention, the target is fixed to a first end of the driven shaft via a target support. Said driven shaft is guided in rotation by a first bearing surrounding the target support and by a second bearing surrounding the driven shaft at a second end of the driven shaft.

According to the invention, the second pinion is located substantially in the middle of the driven shaft between the first and the second bearing.

According to another feature of the invention, the actuator comprises a casing able to be fixed on the transmission of the vehicle and in which are housed the electric motor, the toothed wheel, the driven shaft via its bearings, and the sensor. The casing moreover comprises an electrical connector in order to electrically connect the electric motor and the sensor to an electrical power source.

According to the invention, the electrical connector is connected to the electric motor and to the sensor by way of overmoulded conductive tracks in the casing.

According to one feature of the invention, the electric motor, the driven shaft and the sensor are held in the casing by fixing means in the form of clips.

Other features and advantages of the invention will emerge upon reading the following text of exemplary embodiments described in detail, with reference to the appended figures:

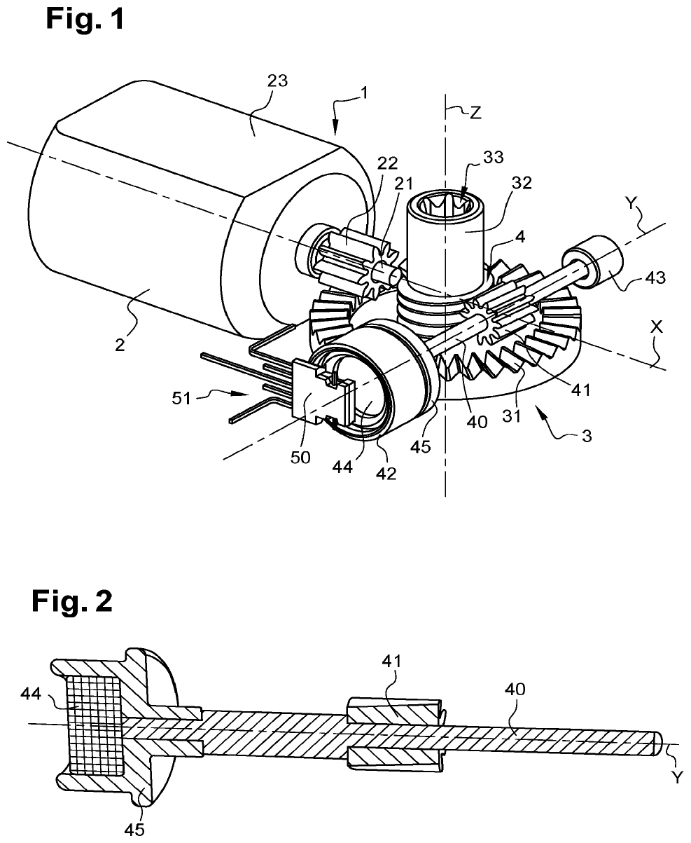

FIG. 1 shows a perspective view of the actuator mechanism according to a first embodiment;

FIG. 2 shows a view in section of the driven shaft of the actuator on which the target and the second pinion are mounted;

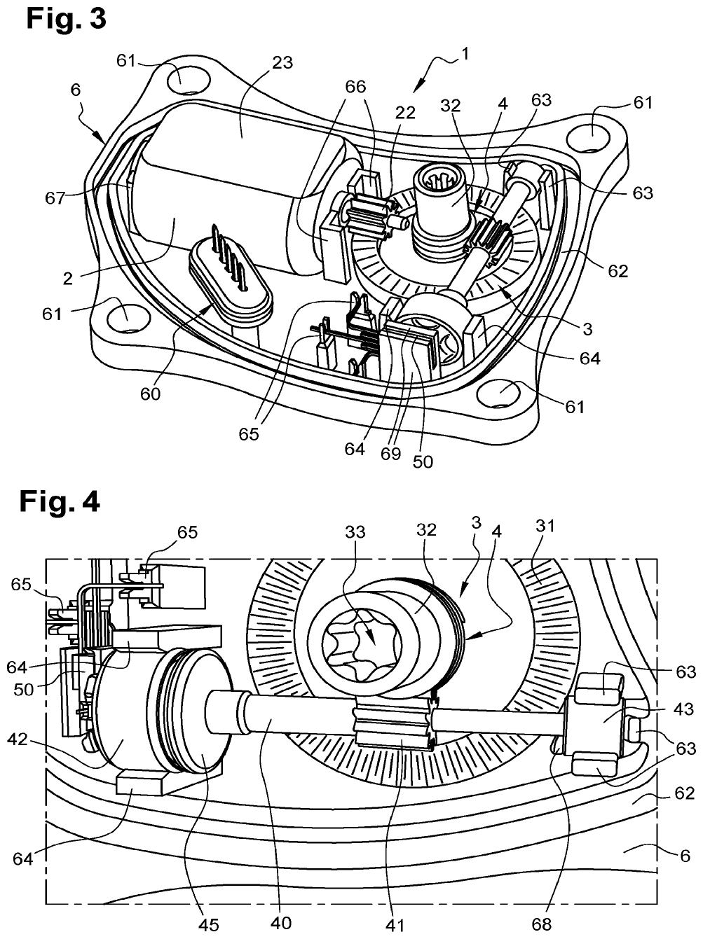

FIG. 3 shows the mechanism from FIG. 1 incorporated in a casing;

FIG. 4 shows a top view of the actuator from FIG. 3, in particular with a focus on the fixing of the driven shaft in the casing;

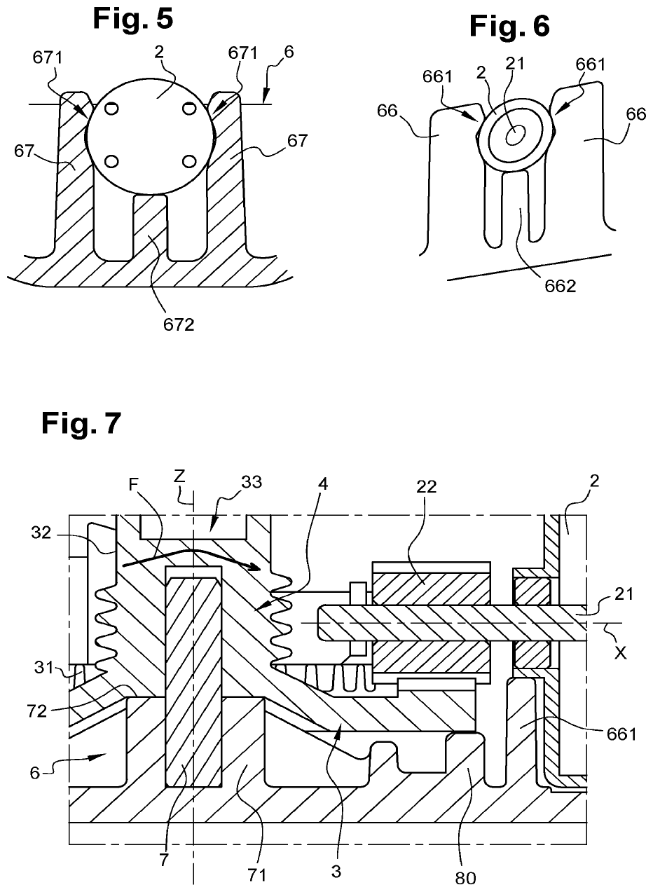

FIG. 5 and FIG. 6 show a view in section of the fixing means of the electric motor;

FIG. 7 shows a view in section of the actuator along an axis passing through the rotary axis of the toothed wheel and the driving shaft of the electric motor;

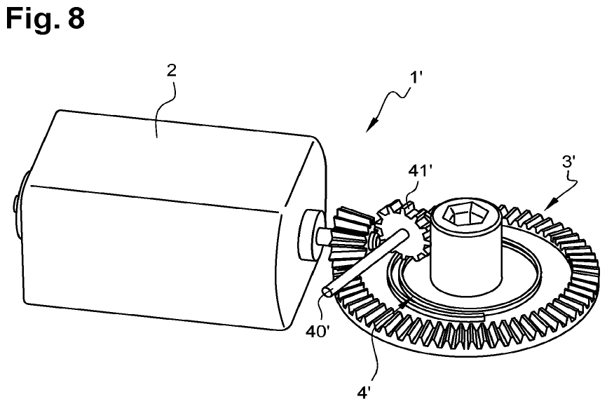

FIG. 8 shows a perspective view of the actuator mechanism according to a second embodiment.

In the remainder of the description, elements that are identical or that perform identical functions have been designated with the same reference sign. For the sake of the conciseness of the present description, these elements are not described in detail in each embodiment, and only the differences between the variant embodiments are described in detail.

FIG. 1 illustrates a coordinate system X, Y, Z. The direction or axis X corresponds to a longitudinal direction. The transverse direction or axis Y is defined as being perpendicular to the longitudinal direction X. More specifically, the longitudinal and transverse directions X and Y may for example belong substantially to a substantially horizontal plane. The direction or axis Z for its part corresponds to a vertical direction.

FIG. 1 shows the internal mechanism of the actuator 1 in a first mode of the invention. The mechanism is formed by a DC electric motor 2 having a driving shaft 21 on which a first pinion 22 is jointly mounted. The first pinion 22 may be made of plastic or metal. For compactness reasons, the electric motor 2 is a flat motor, that is to say that the frame of the electric motor 2 has two flat portions 23 which reduce its vertical bulk. The shaft 21 extends along the axis X.

The first pinion 22, which is a straight pinion, interacts with a toothed wheel 3. In the illustrated example, the axis of rotation Z of the toothed wheel 3 is not only perpendicular, but also coincides with the axis X of the driving shaft 21 of the electric motor 2. The toothed wheel 3 has so-called axial toothing 31, which is formed by gear teeth having a foot-head extension in the direction of the rotation axis Z of the toothed wheel, and which meshes with the pinion 22 of the electric motor 2 to form a face gear. The toothed wheel 3 comprises a first part in the form of a disc with an inner face and an outer face, said faces being perpendicular to the Z axis. The first part in the form of a disc extends substantially through a plane parallel to the plane defined by the longitudinal and transverse directions X and Y. The inner face is defined as being the face that faces the casing 6 (not visible in FIG. 1). The outer face is defined as being the face opposite to the inner face. The toothing 31 is formed on the periphery of the outer face of the toothed wheel 3. It is thus understood that the toothing 31, taken as a whole, extends in a ring around the axis of rotation Z of the toothed wheel 3. The width of the toothing 31 thus corresponds to the extent of the teeth of the toothing 31 in a radial direction with respect to the axis of rotation Z. The toothed wheel 3 moreover comprises a second part in the form of a bushing 32 which extends vertically from the outer face of the first part and on which the torque output element 33 is located. The second part in the form of a bushing 32 extends vertically along the axis Z, that is to say that the bushing 32 extends perpendicularly with respect to the first part in the form of a disc.

In this instance, the torque output element 33 is a connecting means in the form of a female star-shaped end piece in which is fitted a member of the transmission, for example a transmission shaft, on which a shuttle which makes it possible to select a gear ratio moves linearly. In a variant which is not shown, the torque output element 33 may be a male star-shaped end piece. Any other means that make it possible to transmit torque are conceivable for the torque output element 33.

The first part and the second part of the toothed wheel 3 are in one piece, that is to say that the toothed wheel 3 is made of just one material, for example plastic, more specifically polyoxymethylene. The rotational torque supplied by the electric motor thus passes via the first pinion 22, and then via the toothed wheel 3, and is transmitted to the mobile member of the transmission (not shown) via the torque output element 33.

In order to know exactly the position of the mobile member of the transmission and therefore the gear ratio engaged, it is necessary to know the angular position of the toothed wheel 3. For reasons of vertical compactness of the actuator 1, it is impossible to position a magnet and a sensor along the axis Z, and it is therefore necessary to offset the magnet and the sensor in another direction which does not have an impact on the compactness of the actuator along the axis Z.

To do this, the toothed wheel 3 comprises an endless screw mechanism 4 which meshes with a second pinion 41 mounted on a driven shaft 40. The endless screw mechanism is a thread. In the embodiment of FIG. 1, the endless screw mechanism 4 is located on the second part in the form of a bushing 32 of the toothed wheel 3. The endless screw mechanism 4 is located on the bushing 32 close to the first part of the toothed wheel 3. The gear reduction ratio of the endless screw mechanism 4 is determined such that, for a determined number of revolutions of the toothed wheel 3, the shaft 40 revolves only once.

In the present case, the gear reduction ratio is such that the toothed wheel 3 revolves eleven times, that is to say 3960°, whereas the shaft 40 revolves once, that is to say 360°. The eleven revolutions of the toothed wheel 3 correspond to the movement of the mobile member of the transmission between its two end positions, making it possible to cover all of the gear ratio changes. The number of teeth of the second pinion 41 is identical to the number of revolutions necessary for the toothed wheel 3 to move the mobile member of the transmission between its two end positions plus a clearance of one tooth which corresponds to an additional revolution. In the present case, the pinion 41 has eleven teeth, corresponding to the eleven revolutions of the toothed wheel 3.

The shaft 40 will now be described with reference to FIGS. 1 and 2. The shaft 40 extends along the axis Y and is composed of a metal shaft on which is mounted the second pinion 41 which cooperates with the endless screw mechanism 4 of the toothed wheel 3. As a variant, the shaft 40 may be made of plastic. The second pinion 41 may be made of plastic or metal. A target 44 facing a sensor 50 is fixed to a first end of the shaft 40 via a target support 45.

In this instance, the target 44 is a magnetic target, that is to say that the target 44 is a permanent magnet. The target 44 thus generates a magnetic field intended to influence the magnetic sensor 50, which is in particular a Hall effect sensor. It is thus possible, depending on the signal emitted by the sensor 50, to determine the exact position of the mobile member of the transmission between its two end positions.

The target 44 is cylindrical and centred on the axis Y. The target 44 is mounted and held in the target support 45 by a fixing means, for example by adhesive bonding or by overmoulding. The target support 45 is a substantially cylindrical part made from plastic, in particular polyoxymethylene, and is connected to the shaft 40. For example, the target support 45 is fitted and adhesively bonded on the shaft 40. As a variant, the target support 45 and the shaft are in one piece. The inner surface of the target support 45 receives the target 44 and the outer surface of the target support 45 receives a first bearing 42 for guiding the shaft 40.

The shaft 40 is guided in rotation by the first bearing 42 surrounding the target support 45 and by a second bearing 43 surrounding the shaft 40 at a second end of the shaft 40. The bearings 42, 43 are bronze or brass bearings. As a variant, the bearings 42, 43 may be made of plastic, for example of polyether ether ketone. The bearings 42, 43 have different diameters. The first pinion 42 surrounding the target support 45 has a larger diameter than the second bearing 43. The second pinion 41 is located substantially in the middle of the shaft 40 between the first bearing 42 and the second bearing 43.

FIG. 3 shows the mechanism from FIG. 1 incorporated in a casing 6. The casing 6 is able to be fixed on the transmission of the vehicle, in particular by fixing means, for example screws, passing through multiple openings 61 made on the periphery of the casing 6. A seal is disposed in a peripheral groove 62 of the casing 6 in order to ensure leaktightness between the casing 6 of the actuator 1 and the transmission. The seal is made of EPDM or FKM or silicone, for example. The casing is made of plastic, for example, in particular glass-fibre-reinforced plastic.

The casing 6 houses the electric motor 2, the toothed wheel 3, the shaft 40, and the sensor 50 in its internal volume. The casing 6 moreover comprises an electrical connector 60 in order to electrically connect the electric motor 2 and the sensor 50 to an electrical power source. The electrical connector 60 also makes it possible to retrieve the signal emitted by the sensor 50. The electrical connector 60 is connected to the electric motor 2 and to the sensor 50 by way of overmoulded conductive tracks in the casing 6. The connector 60 is leaktight and incorporates a seal.

The electric motor 2, the shaft 40 and the sensor 50 are held in the casing 6 by fixing means in the form of clips. FIGS. 3, 5 and 6 illustrate these fixing means. FIG. 5 shows the rear part of the electric motor 2 that is fixed to the casing 6 by two clips 671 formed by two protuberances 67 of the casing 6 and by a stop 672. The stop 672 is used for positioning on the casing 6 and the two clips 671 are used to hold the electric motor 2 in position in the casing 6.

The same principle is used to fix the front part of the electric motor, as is illustrated in FIG. 6. The front part of the electric motor 2 is fixed to the casing 6 by two clips 661 formed by two protuberances 66 of the casing 6 and by a stop 662. The stop 662 is used for positioning on the casing 6 and the two clips 661 are used to hold the electric motor 2 in position in the case 6.

With reference to FIGS. 3 and 4, the shaft 40 is likewise fixed to the casing 6 by fixing means in the form of clips. The first bearing 42 is fixed to the casing 6 by two clips 64 formed by two protuberances of the casing 6. The second bearing 43 is fixed to the casing 6 by three clips 63 formed by three protuberances of the casing 6. In order to block the translational movement of the shaft 40 in the direction Y, a peg 68 is formed by a protuberance of the casing 6. As an alternative to the peg 68, the shaft 40 can be blocked in the direction Y by a protuberance of one of the clips 63 in the direction of the shaft 40.

The sensor 50 is likewise fixed to the casing 6 by fixing means in the form of clips; the sensor 50 is in particular positioned between two walls 69. The electrical connections of the sensor 50 are connected to the overmoulded conductive tracks of the casing 6 by connection pins 65.

FIG. 7 shows the rotational guidance of the toothed wheel 3 in the casing 6 via a shaft 7. The shaft 7 is inserted in a guide bushing 71 of the casing 6. The shaft 7 may be fitted in the bushing 71 with an adhesive bond or be overmoulded in the bushing 71. The toothed wheel 3 butts against one end 72 of this guide bushing 71 in order to be blocked in translational movement along the axis Z. While the actuator 1 is operating, it may be that the toothed wheel 3 rolls owing to the pressure angle of the face gear between the first pinion 22 and the toothing 31, tending to make the toothed wheel tilt in a direction along the arrow F. In order to counter this inconvenience, a peg 80 is disposed in the casing 6 facing the inner face of the first part of the toothed wheel 3 at the toothing 31. The peg 80 protrudes in the direction of the toothed wheel 3 and of the first pinion 22. In other words, the peg 80 protrudes in line with the first pinion 22 from the casing 6 and the toothed wheel 3 is located between the peg 80 and the first pinion in the direction of extent of the peg 80. The peg 80 extends in a direction parallel to the direction Z. The peg 80 is cylindrical. A clearance of between 0.1 mm and 1 mm is defined between the peg 80 and the toothed wheel 3.

FIG. 8 illustrates an actuator 1′ according to a second embodiment of the invention. What is different from the first embodiment is that the endless screw mechanism 4′ of the actuator 1′ is located on the first part in the form of a disc on the outer face of the toothed wheel 3′. The endless screw mechanism 4′ thus forms a helical camway. The operation is identical to the first embodiment, that is to say that the gear reduction ratio of the endless screw mechanism 4′ is determined such that, for a determined number of revolutions of the toothed wheel 3′, the shaft 40′ revolves only once.

Although the invention has been described in connection with multiple particular embodiments, it is quite obvious that it is in no way limited thereto and that it comprises all the technical equivalents of the means described and combinations thereof where these fall within the scope of the invention.

In the claims, any reference sign between parentheses should not be interpreted as limiting the claim.

1. Actuator for the actuation of at least one movable member of a vehicle transmission, said actuator comprising an electric motor having a driving shaft on which is mounted a first pinion, a toothed wheel having toothing which mesh with the first pinion, and a torque output element able to be coupled to the transmission, wherein the toothed wheel moreover comprises an endless screw mechanism meshing with a second pinion mounted on a driven shaft, said driven shaft comprising a magnetic target facing a sensor.

2. Actuator according to claim 1, wherein the first pinion and the toothing of the toothed wheel form a face gear.

3. Actuator according to claim 1, wherein the toothed wheel comprises a first part in the form of a disc with an inner face and an outer face, said toothing are formed on the periphery of the outer face, the toothed wheel moreover comprises a second part in the form of a bushing extending from the outer face of the first part and on which the torque output element is located, said first part and second part are in one piece.

4. Actuator according to claim 3, wherein the endless screw mechanism is located on the second part in the form of a bushing of the toothed wheel.

5. Actuator according to claim 3, wherein the endless screw mechanism is located on the first part in the form of a disc on the outer face of the toothed wheel.

6. Actuator according to claim 1, wherein the target is fixed to a first end of the driven shaft via a target support, said driven shaft being guided in rotation by a first bearing surrounding the target support and by a second bearing surrounding the driven shaft at a second end of the driven shaft.

7. Actuator according to claim 6, wherein the second pinion is located substantially in the middle of the driven shaft between the first and the second bearing.

8. Actuator according to claim 1, wherein it comprises a casing able to be fixed on the transmission of the vehicle and in which are housed the electric motor, the toothed wheel, the driven shaft and the sensor, said casing moreover comprising an electrical connector in order to electrically connect the electric motor and the sensor to an electrical power source.

9. Actuator according to claim 8, wherein the electrical connector is connected to the electric motor and to the sensor by way of overmoulded conductive tracks in the casing.

10. Actuator according to claim 8, wherein the electric motor, the driven shaft and the sensor are held in the casing by fixing means in the form of clips.

11. Actuator according to claim 2, wherein the toothed wheel comprises a first part in the form of a disc with an inner face and an outer face, said toothing are formed on the periphery of the outer face, the toothed wheel moreover comprises a second part in the form of a bushing extending from the outer face of the first part and on which the torque output element is located, said first part and second part are in one piece.

12. Actuator according to claim 2, wherein the target is fixed to a first end of the driven shaft via a target support, said driven shaft being guided in rotation by a first bearing surrounding the target support and by a second bearing surrounding the driven shaft at a second end of the driven shaft.

13. Actuator according to claim 2, wherein it comprises a casing able to be fixed on the transmission of the vehicle and in which are housed the electric motor, the toothed wheel, the driven shaft and the sensor, said casing moreover comprising an electrical connector in order to electrically connect the electric motor and the sensor to an electrical power source.

14. Actuator according to claim 9, wherein the electric motor, the driven shaft and the sensor are held in the casing by fixing means in the form of clips.

15. Actuator according to claim 3, wherein the target is fixed to a first end of the driven shaft via a target support, said driven shaft being guided in rotation by a first bearing surrounding the target support and by a second bearing surrounding the driven shaft at a second end of the driven shaft.

16. Actuator according to claim 3, wherein it comprises a casing able to be fixed on the transmission of the vehicle and in which are housed the electric motor, the toothed wheel, the driven shaft and the sensor, said casing moreover comprising an electrical connector in order to electrically connect the electric motor and the sensor to an electrical power source.

17. Actuator according to claim 4, wherein the target is fixed to a first end of the driven shaft via a target support, said driven shaft being guided in rotation by a first bearing surrounding the target support and by a second bearing surrounding the driven shaft at a second end of the driven shaft.

18. Actuator according to claim 4, wherein it comprises a casing able to be fixed on the transmission of the vehicle and in which are housed the electric motor, the toothed wheel, the driven shaft and the sensor, said casing moreover comprising an electrical connector in order to electrically connect the electric motor and the sensor to an electrical power source.

19. Actuator according to claim 5, wherein the target is fixed to a first end of the driven shaft via a target support, said driven shaft being guided in rotation by a first bearing surrounding the target support and by a second bearing surrounding the driven shaft at a second end of the driven shaft.

20. Actuator according to claim 6, wherein it comprises a casing able to be fixed on the transmission of the vehicle and in which are housed the electric motor, the toothed wheel, the driven shaft and the sensor, said casing moreover comprising an electrical connector in order to electrically connect the electric motor and the sensor to an electrical power source.
